(19) United States
(12) Patent Application Publication
(10) Pub. No.: US 2016/0125180 A1
(43) Pub. Date: May 5, 2016

(54) Near Field Communication Authentication Mechanism

(71) Applicant: Intel Corporation, Santa Clara, CA (US)

(72) Inventors: Ned M. Smith, Hillsboro, OR (US); Victoria C. Moore, Phoenix, AZ (US); Avi Kannon, Jerusalem (IL); Ehud Reshef, Kiryat Tivon (IL); Alex Nayshtut, Gan Yavne (IL); Oleg Pogorelik, Lapid (IL); Abhilasha Bhargav-Spantzel, Santa Clara, CA (US); Craig T. Owen, Folsom, CA (US); Hormuzd M. Khosravi, Portland, OR (US)

(21) Appl. No.: 14/361,877

(22) PCT Filed: Dec. 12, 2013
(86) PCT No.: PCT/US2013/074623

§ 371 Date: May 30, 2014

(51) Int. Cl. G06F 21/34; H04L 9/32; H04W 12/06; H04L 29/06

(52) U.S. Cl. CPC G06F 21/34; H04L 63/0853; H04L 9/3234; H04L 63/102; H04W 12/06

(57) ABSTRACT

A computing device is described. The computing device includes input/output (I/O) circuitry to receive sensory data and a trusted execution environment to monitor the I/O circuitry to detect one or more context characteristics of the computing device and to authenticate user identity based on context characteristics.

### FIELD

Embodiments described herein generally relate to computer system user authentication. More particularly, embodiments relate to mechanisms for contextual authentication at computing devices.

### BACKGROUND

In current computer system applications it has become difficult to uniquely identify a user based on standard and traditional authentication methods because identities are easily stolen and fraud is prevalent. Specifically, applications that implement passwords to facilitate user authentication jeopardize security and privacy.

### BRIEF DESCRIPTION OF THE DRAWINGS

Embodiments are illustrated by way of example, and not by way of limitation, in the figures of the accompanying drawings in which like reference numerals refer to similar elements.

FIG. 1 is a block diagram illustrating one embodiment of a network system.

FIG. 2 a block diagram illustrating one embodiment of a local computing device.

FIG. 3 a block diagram illustrating one embodiment of a trusted execution environment.

FIG. 4 is a flow diagram illustrating one embodiment of a process performed by a trusted execution environment.

FIG. 5 is a flow diagram illustrating one embodiment of authentication performed by a trusted execution environment.

FIG. 6 is a flow diagram illustrating one embodiment of identity provisioning performed by a trusted execution environment.

FIG. 7 is a flow diagram illustrating another embodiment of authentication performed by a trusted execution environment.

FIG. 8 is a block diagram illustrating another embodiment of a trusted execution environment.

FIG. 9 is a flow diagram illustrating another embodiment of authentication performed by a trusted execution environment.

FIG. 10 is a flow diagram illustrating one embodiment of a remote attestation process.

### DETAILED DESCRIPTION

In the following description, numerous specific details are set forth. However, embodiments, as described herein, may be practiced without these specific details. In other instances, well-known circuits, structures and techniques have not been shown in details in order not to obscure the understanding of this description.

Throughout this document, terms like “logic”, “component”, “module”, “framework”, “engine”, “store”, or the like, may be referenced interchangeably and include, by way of example, software, hardware, and/or any combination of software and hardware, such as firmware.

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

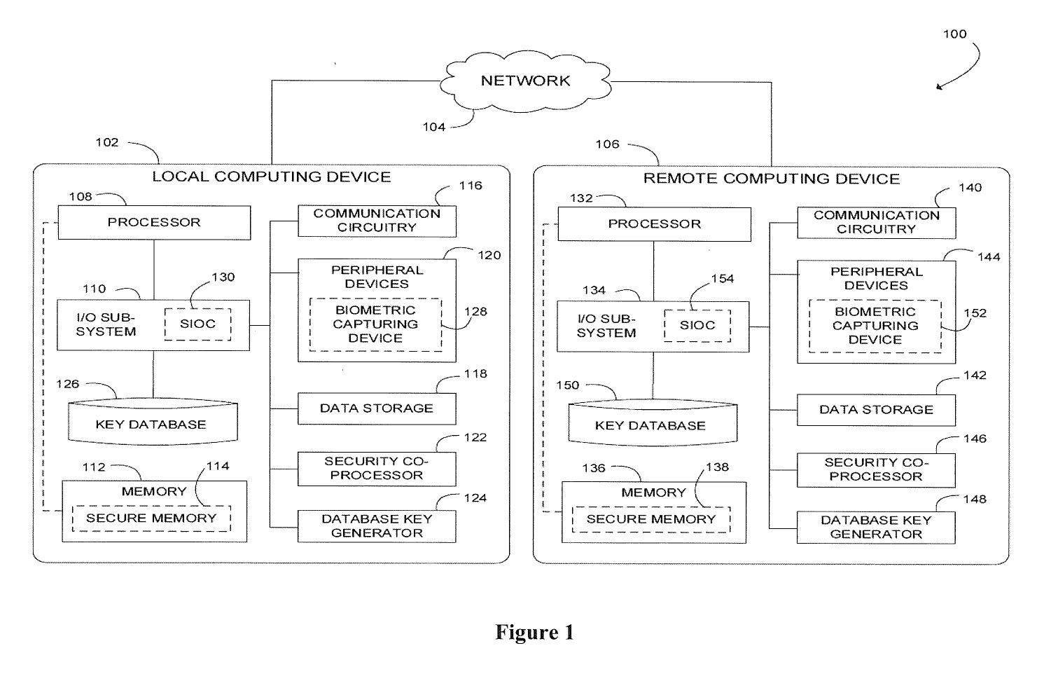

FIG. 1 discloses a system 100 that includes a local computing device 102, a network 104, and a remote computing device 106. In use, as discussed in more detail below, the local computing device 102 and the remote computing device 106 may communicate with one another over the network 104 to establish a unilateral, bilateral, or multilateral trust relationship. Although only one local computing device 102, one network 104, and one remote computing device 106 are illustratively shown in FIG. 1, the system 100 may include any number of local computing devices 102, networks 104, and remote computing device 106 in other embodiments.

The local computing device 102 may be embodied as any type of computing device capable of performing the function described herein. For example, the local computing device 102 may be embodied as a desktop computer, a laptop computer, a mobile internet device, a handheld computer, a smartphone, a personal digital assistant, a telephony device, or other computing device. In the illustrative embodiment of FIG. 1, the local computing device 102 includes a processor 108, an I/O subsystem 110, a memory 112, a communication circuitry 116, a data storage device 118, one or more peripheral devices 120, a security co-processor 122, a database key generator 124, and a key database 126.

The local computing device 102 may also include a secure memory 114, a biometric capturing device 128, and a secure input/output circuitry 130. In some embodiments, several of the foregoing components may be incorporated on a motherboard of the local computing device 102, while other components may be communicatively coupled to the motherboard via, for example, a peripheral port. Furthermore, it should be appreciated that the local computing device 102 may include other components, sub-components, and devices commonly found in a computer and/or computing device, which are not illustrated in FIG. 1 for clarity of the description.

The processor 108 of the local computing device 102 may be embodied as any type of processor capable of executing software/firmware, such as a microprocessor, digital signal processor, microcontroller, or the like. In some embodiments, the processor 108 may be a single core processor having a processor core. However, in other embodiments, the processor 108 may be embodied as a multi-core processor having multiple processor cores. Additionally, the local computing device 102 may include additional processors 108, each having one or more processor cores.

The I/O subsystem 110 of the local computing device 102 may be embodied as circuitry and/or components to facilitate input/output operations with the processor 108 and/or other components of the local computing device 102. In some embodiments, the I/O subsystem 110 may be embodied as a memory controller hub (MCH or “northbridge”), an input/output controller hub (ICH or “southbridge”), and a firmware device. In such embodiments, the firmware device of the I/O subsystem 110 may be embodied as a memory device for storing Basic Input/Output System (BIOS) data and/or instructions and/or other information (e.g., a BIOS driver used during booting of the local computing device 102).

However, in other embodiments, I/O subsystems having other configurations may be used. For example, in some embodiments, the I/O subsystem 110 may be embodied as a platform controller hub (PCH). In such embodiments, the memory controller hub (MCH) may be incorporated in or otherwise associated with the processor 108, and the processor 108 may communicate directly with the memory 112 (as shown by the hashed line in FIG. 1). Additionally, in other embodiments, the I/O subsystem 110 may form a portion of a system-on-a-chip (SoC) and be incorporated, along with the processor 108 and other components of the local computing device 102, on a single integrated circuit chip.

The processor 108 is communicatively coupled to the I/O subsystem 110 via a number of signal paths. These signal paths (and other signal paths illustrated in FIG. 1) may be embodied as any type of signal paths capable of facilitating communication between the components of the local computing device 102. For example, the signal paths may be embodied as any number of wires, cables, light guides, printed circuit board traces, via, bus, intervening devices, and/or the like.

The memory 112 of the local computing device 102 may be embodied as or otherwise include one or more memory devices or data storage locations including, for example, dynamic random access memory devices (DRAM), synchronous dynamic random access memory devices (SDRAM), double-data rate synchronous dynamic random access memory device (DDR SDRAM), mask read-only memory (ROM) devices, erasable programmable ROM (EPROM), electrically erasable programmable ROM (EEPROM) devices, flash memory devices, and/or other volatile and/or non-volatile memory devices. The memory 112 is communicatively coupled to the I/O subsystem 110 via a number of signal paths. Although only a single memory device 112 is illustrated in FIG. 1, the local computing device 102 may include additional memory devices in other embodiments. Various data and software may be stored in the memory device 112. For example, one or more operating systems, applications, programs, libraries, and drivers that make up the software stack executed by the processor 108 may reside in memory 112 during execution. Furthermore, software and data stored in memory 112 may be swapped between the memory 112 and the data storage 118 as part of memory management operations.

The communication circuitry 116 of the local computing device 102 may be embodied as any number of devices and circuitry for enabling communications between the local computing device 102 and remote computing devices (e.g., the remote computing device 106) via the network 104. The network 104 may be embodied as any number of various wired and/or wireless communication networks. For example, the network 104 may be embodied as or otherwise include a local area network (LAN), a wide area network (WAN), or a publicly-accessible, global network such as the Internet. In some embodiments, network 104 may incorporate a layer of link level security.

Additionally, the network 104 may include any number of additional devices to facilitate communication between the local computing device 102 and the remote computing device 106. The local computing device 102 and the remote computing device 106 may use any suitable communication protocol to communicate with each other over the network 104 depending on, for example, the particular type of network(s) 104. In some embodiments, the local computing device 102 and the remote computing device 106 may communicate with each other over the network 104 using a version of the standardized Internet Key Exchange (IKE) protocol. In other embodiments, the local computing device 102 and remote computing device 106 may communicate using a SIGMA Sign-and-MAC protocol (e.g., any variant of the SIGMA Sign-and-Mac algorithm including, but not limited to, SIGMA-I, SIGMA-R, SIGMA-4, and/or JFK).

The data storage device(s) 118 may be embodied as any type of device or devices configured for the short-term or long-term storage of data such as, for example, memory devices and circuits, memory cards, hard disk drives, solid-state drives, or other data storage devices. The encrypted key database 126 of the local computing device 102 may be stored in the data storage device 118. In one embodiment, the key database 126 may be encrypted using a database wrapper key, which may be a symmetric cryptographic key generated as a function of hardware of the local computing device 102. For example, in some embodiments, the database wrapper key may be generated using a Physical Unclonable Function (PUF or PUFS) and/or PUF circuitry.

The peripheral devices 120 of the local computing device 102 may include any number of peripheral or interface devices. For example, the peripheral devices 120 may include a display, a keyboard, a mouse, external speakers, and/or other peripheral devices. The particular devices included in the peripheral devices 120 may depend upon, for example, the intended use of the local computing device 102. The peripheral devices 120 are communicatively coupled to the I/O subsystem 110 via a number of signal paths thereby allowing the I/O subsystem 110 and/or processor 108 to receive inputs from and send outputs to the peripheral devices 120.

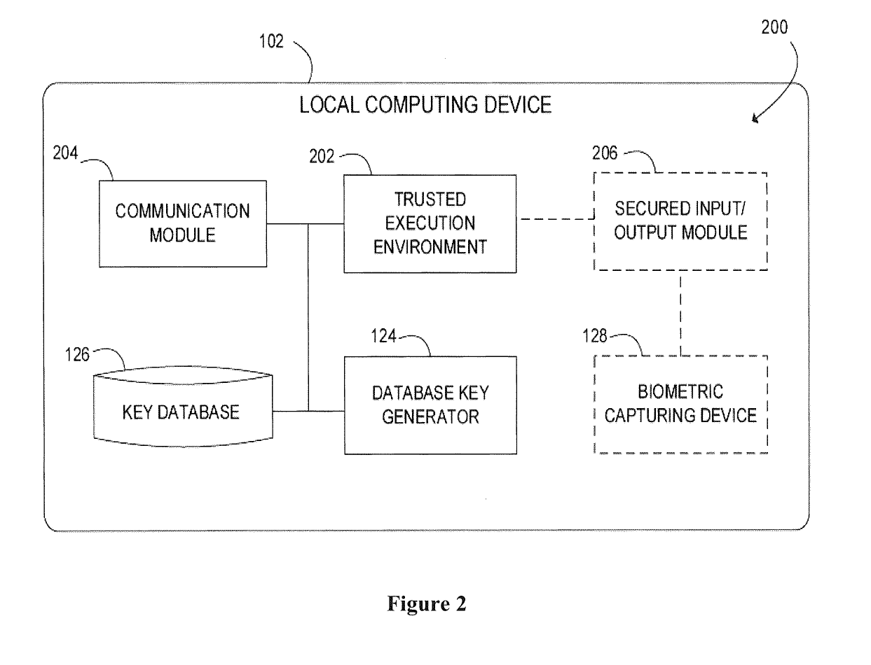

The security co-processor 122 may embodied as any hardware component(s) or circuitry capable of establishing a trusted execution environment 202 (see FIG. 2). For example, the security co-processor 122 may be embodied as a Trusted Platform Module (TPM), a manageability engine (ME), or an out-of-band processor. In some embodiments, a public Enhanced Privacy Identification (EPID) key and a private EPID key may be provisioned into the security co-processor 122 during the manufacturing process of the security co-processor 122. In other embodiments, EPID keys may be provisioned into one or more other components of the local computing device 102.

The EPID keys are associated with a group having a single public EPID key. Any private EPID, of which there may be many, belonging to the group may be paired with the public EPID key as a valid public-private cryptographic pair. For example, the security co-processor 122 of the local computing device 102 may have one private EPID key and the security co-processor 146 of the remote computing device 106 may have a different private EPID key. If the security co-processor 122 and the security co-processor 146 are members of the same group, then both of their private EPID keys are valid asymmetric key pairs with the same public EPID key. As such, EPID keys allow both anonymity and unlinkability of the members. In other embodiments, another one-to-many cryptographic scheme may be used.

The database key generator 124 may embodied as any hardware component or circuitry capable of generating a database wrapper key as a function of the hardware of the local computing device 102. For example, the database key generator 124 may include PUF circuitry or circuit elements or otherwise use a tamper-resistant hardware entropy source (e.g., based on PUF technology) to generate the database wrapper key. In some embodiments, the database key generator 124 may also include error correction circuits or logic associated with the PUF circuitry.

The database key generator 124 may be implemented upon boot of the local computing device 102 to generate the database wrapper key (i.e., a symmetric cryptographic key), which may be used to decrypt the key database 126. The key database 126 may be any electronic arrangement or structure suitable for storing cryptographic keys and unique device/entity identifiers. In the illustrative embodiment, the key database 126 is encrypted with the database wrapper key and stored in persistent storage such as, for example, the data storage device 118. In order to access cryptographic keys or otherwise update the key database 126, the trusted execution environment 202 retrieves the encrypted key database 126 from the data storage device 118 and decrypts the encrypted key database 126 with the database wrapper key.

The local computing device 102 may include secure memory 114, biometric capturing device 128, and secure input/output circuitry 130 in embodiments that require user presence to be verified on the local computing device 102. In such embodiments, the secure input/output circuitry 130 may be included in the I/O subsystem 110 and is a hardware reinforced path to securely transfer media. Additionally, the memory 112 may include a portion of secure memory 114. The secure memory 114 may be used for hardware-enforced protection between the application(s) and hardware.

In some embodiments, the secure memory 114 may be included on a processor graphics circuitry or a graphics peripheral card or may be a separate partition of the memory 112 for use by the processor graphics circuitry or graphics peripheral card. In one embodiment, Protected Audio Video Path (PAVP) and/or Protected Transaction Display (PTD) technology may be used to implement such hardware reinforced security using the secure memory 114 and the secure input/output circuitry 130. For example, in some embodiments, a Protected Transaction Display may be used to authenticate the user via a randomized Personal Identification Number (PIN) pad that is virtually displayed on a display of the local computing device 102 via a Protected Audio Video Path. Furthermore, it should be appreciated that alternative implementations of hardware reinforced security may use the secure memory 114 and the secure input/output circuitry 130 to verify user presence.

The biometric capturing device 128 may be embodied as any type of biometric capturing device that is capable of generating real-time biometric data of a user of the local computing device 102. For example, the biometric capturing device 128 may be embodied as a camera, such as a still camera, a video camera, or the like, that is capable of generating real-time images of a user of the local computing device 102. Alternatively or in addition, the biometric capturing device 128 may include a fingerprint scanner, handprint scanner, iris scanner, retinal scanner, or voice analyzer. The biometric capturing device may also include a biometric system, which may be embodied as any type of biometric system including multimodal biometric systems. In some embodiments, the biometric capturing device 128 may be incorporated into a housing of the local computing device 102. For example, the biometric capturing device 128 may be a camera incorporated near the display screen of the local computing device 102 (e.g., a webcam). In particular, the camera may capture the facial image of the current user of the local computing device 102. In other embodiments, the biometric capturing device 128 may be a peripheral device communicatively coupled to the local computing device 102.

The remote computing device 106 may be similar to the local computing device 102. As such, the remote computing device 106 may be embodied as any type of computing device capable of performing the functions described herein. In the illustrative embodiment of FIG. 1, the remote computing device 106 includes a processor 132, an I/O subsystem 134, a memory 136, a communication circuitry 140, a data storage device 142, one or more peripheral devices 144, a security co-processor 146, a database key generator 148, and a key database 150.

The remote computing device 106 may also include a secure memory 138, a biometric capturing device 152, and a secured input/output circuitry 154. In some embodiments, several of the foregoing components may be incorporated on a motherboard of the remote computing device 106, while other components may be communicatively coupled to the motherboard via, for example, a peripheral port. Furthermore, it should be appreciated that the remote computing device 106 may include other components, sub-components, and devices commonly found in a computer and/or computing device, which are not illustrated in FIG. 1 for clarity of the description.

The processor 132, the I/O subsystem 134, the memory 136, the secure memory 138, the communication circuitry 140, the data storage device 142, the one or more peripheral devices 144, the security co-processor 146, the database key generator 148, the key database 150, the biometric capturing device 152, and the secure input/output circuitry 154 may be similar to the corresponding components of the local computing device 102 as described above. As such, the descriptions of such similar components of the local computing device 102 is equally applicable to the similar components of the remote computing device 106 and are not repeated herein for clarity of the description.

In use, as shown in FIG. 2, the local computing device 102 may establish a trusted environment 200. The environment 200 in the illustrative embodiment includes a trusted execution environment 202, a database key generator 124, a key database 126, a communication module 204, a secured input/output module 206, and a biometric capturing device 128.

The trusted execution environment 202 may be implanted by the security co-processor 122 to establish a secure environment. In some embodiments, the cryptographic keys stored in the key database 126 may only be accessed by the trusted execution environment 202 when in use. When not in use, the key database 126 may be encrypted with the database wrapper key generated by the database key generator 124 and stored in the data storage device 118. In the illustrative embodiment of FIG. 2, the cryptographic key stored in the key database 126 and the database wrapper key generated by the database key generator 124 are inaccessible to the processor 108. As such, in some embodiments, only the trusted execution environment 202 may access the database wrapper key. In some embodiments, the environment 200 may also include the secured input/output module 206, which may be software/firmware designed to securely interact with the secure input/output circuitry 130 in the I/O subsystem 110 of the local computing device 102.

The communication module 204 may handle the communication between the local computing device 102 and remote computing devices, including the remote computing device 106, through the network 104. In a further embodiment, communication module 204 facilitates communication via NFC or Bluetooth. In such an embodiment, communication module 204 includes a NFC reader that may communicate with a NFC device or a remote computing device 106.

Each of the trusted execution environment 202, the database key generator 124, the key database 126, the communication module 204, the secured input/output module 206, and the biometric capturing device 128 may be embodied as hardware, software, firmware, or a combination thereof. It should be appreciated that the remote computing device 106 may establish an environment similar to the environment 200 for communicating with the local computing device 102. For example, the remote computing device 106 may also have a trusted execution environment that may communicate with the trusted execution environment 202 of the local computing device 102 through the communication module 204.

As discussed above, conventional password authentication mechanisms are inadequate due to security deficiencies. According to one embodiment, trusted execution environment 202 uses context based authentication to reduce dependence on passwords. In such an embodiment, trusted execution environment 202 implements context-based characteristic of local computing device 102 to verify the identity of a user. Context characteristics can identify attributes that provide a unique identifier without disclosing other identifying attributes that could be targets of identity theft (e.g., name, address, age, etc.).

### Device Authentication

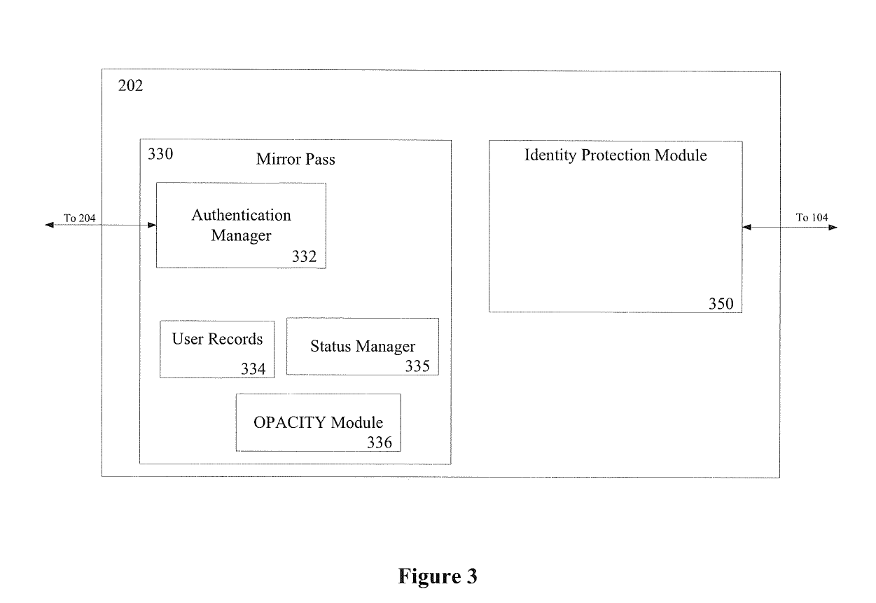

According to one embodiment, trusted execution environment 202 authenticates NFC devices, such as smartcards or NFC enabled computing devices (e.g., smartphones) and monitors user presence. FIG. 3 is a block diagram illustrating one embodiment of such a trusted execution environment 202. According to one embodiment, execution environment 202 includes mirror pass module 330 and identity protection module 350. Mirror pass module 330 is a multi-factor authentication module that includes an authentication manager 332 to provide for the authentication of NFC device (e.g., device) users. In such an embodiment, authentication manager 332 receives a signal indicating that a tap at an NFC reader implemented at computing device 102 has been detected, thus commencing an authentication process.

Mirror pass module 330 receives a user private key exported from the NFC device and data from user records 334 to perform authentication. Once authenticated, status manager 335 monitors user presence. Thus, the NFC card is no longer required. In one embodiment, status manager 335 receives and analyzes signals from a proximity sensor (e.g., infrared, ultrasonic, Bluetooth, etc.) to determine whether a user is still in the vicinity of local computing device 102. In such an embodiment, status manager 335 may receive the signals from the secured input/output module 206 and/or biometric capturing device 128.

In a further embodiment, mirror pass module 330 installs the private key in identity protection module 350 once authentication is successfully performed. Identity protection module 350 is a resource manager that uses the private key received from mirror pass module 330 to establish secure access to a resource at one or more remote computing devices (e.g., remote computing device 106). In one embodiment, mirror pass module 330 disables and removes the private key from identity protection module 350 upon detection that the authenticated user is no longer present.

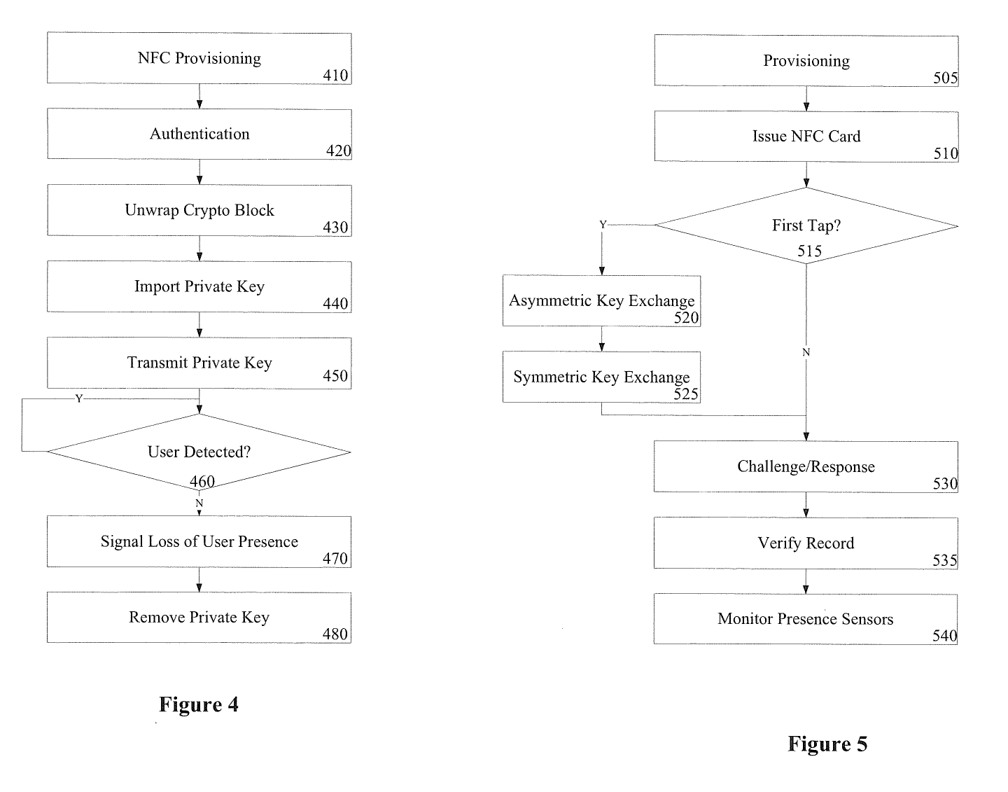

FIG. 4 is a flow diagram illustrating one embodiment of an authentication process performed by a trusted execution environment. At processing block 410, the NFC device is provisioned with a private key. In one embodiment, a certificate is created following PKI practices if certificates are used. In various embodiments, the certificate may be stored on the NFC device, at trusted execution environment 202 or in both places. At processing block 420, a user authenticates using an NFC tap, which results in the private key being exported to trusted execution environment 202. In one embodiment, mirror pass module 330 chooses a randomly generated key export wrapping key. In such an embodiment, the NFC device uses the wrapping key to construct public-key cryptography standards 12 (PKCS12) key export block. Subsequently, the NFC device retains a copy of the private key. The user may then place the NFC card out of range of the NFC reader (e.g., in a pocket).

At processing block 430, mirror pass module 330 unwraps the PKCS12 block and forwards an export key to trusted execution environment 202. At processing block 440, trusted execution environment 202 imports the private key and makes it available for use by host software at computing device 102 or other trusted execution environment 202 services. At processing block 450, remote web/enterprise services at a remote computing device uses the private key to establish secure access to a resource.

At decision block 460, a determination is made as to whether the user continues to be detected. If so, control remains at decision block 460. Otherwise, status manager 335 detects that the user is no longer present and signals identity protection module 350 of the loss of authenticated user presence, processing block 470. At processing block 480, identity protection module 350 removes the imported private key, thus blocking access to the remote. In one embodiment, a device removal notification is displayed.

In other embodiments, NFC devices implement an authentication protocol referred to as Open Protocol for Access Control, Identification, and Ticketing with privacy (OPACITY) protocol that is typically exchanged over NFC airframes. OPACITY is designed to protect against malware in the radio range of an NFC card and the reader. According to one embodiment, mirror pass module 330 includes a module 336 to provide support for the OPACITY authentication protocol. In such an embodiment, the opacity module 336 is implemented in firmware or host-loadable firmware, for pre-boot operation where a 3^{rd} party may selectively update the OPACITY algorithm. In a further embodiment, opacity module 336 is encrypted using the authentication manager 332 storage keys at first time of provisioning.

FIG. 5 is a flow diagram illustrating one embodiment of authentication performed by trusted execution environment 202 using the OPACITY authentication protocol. At processing block 505, a vendor module 336 is provisioned at trusted execution environment 202 as part of manufacturing or initial deployment. In one embodiment, vendor anchor keys are provisioned similarly, while anchor provisioning is achieved using the SIGMA protocol between trusted execution environment 202 and a remote computing device. In a further embodiment, opacity module 336 may be further encrypted using the vendor keys. In still a further embodiment, the vendor keys are protected using the mirror pass module 330 storage key. In such an embodiment, mirror pass module 330 flash storage is used to store wrapped keys locally or stored by the host and dynamically loaded when the OPACITY module 336 is loaded.

At processing block 510, the vendor issues an NFC card including an asymmetric key and user record. At decision block 515, a determination is made as to whether an NFC card tap to an NFC reader at communication module 204 is a first time a user has tapped the particular card. If so, the asymmetric key is used to perform a signed Diffie-Hellman key exchange according to the OPACITY protocol, processing block 520. In one embodiment, trusted execution environment 202 supports pairing relationships with multiple users, where each user may possess multiple paired devices (e.g., smartphone, card or tablet). At processing block 525, symmetric keys SK_{MAC} and SK_{ENC} are remembered for both trusted execution environment 202 and the NFC card.

Subsequently, or if the tap is a subsequent tap for the NFC card, SK_{MAC} and SK_{ENC} are used according to the OPACITY protocol to protect an authentication challenge/response, processing block 530. At processing block 535, the OPACITY module 336 verifies an exchanged user record and passes user record to authentication manager 232 to compare with a user record cached in user records 334. In embodiments where no local cached copy is available, the OPACITY module 336 may contact a server to perform backend verification prior to mirror pass module 330 locally caching the user record. At processing block 540, status manager 335 monitors presence sensors, as discussed above, to detect the loss of an authenticated user presence.

### Smartphone Authentication

A mobile computing device (e.g., smartphone) equipped with an NFC or Bluetooth radio may also be used as an authentication device. However, existing mechanisms require a trusted backend server to provision the smartphone authentication capability. Further, continuum computing device pairing protocols do not ensure that the user intends the smartphone to be used as an authentication factor and do not provision user credentials as part of pairing. Provisioning of user identity can reveal personally identifiable information (PII) to man-in-the-middle attack listeners during provisioning.

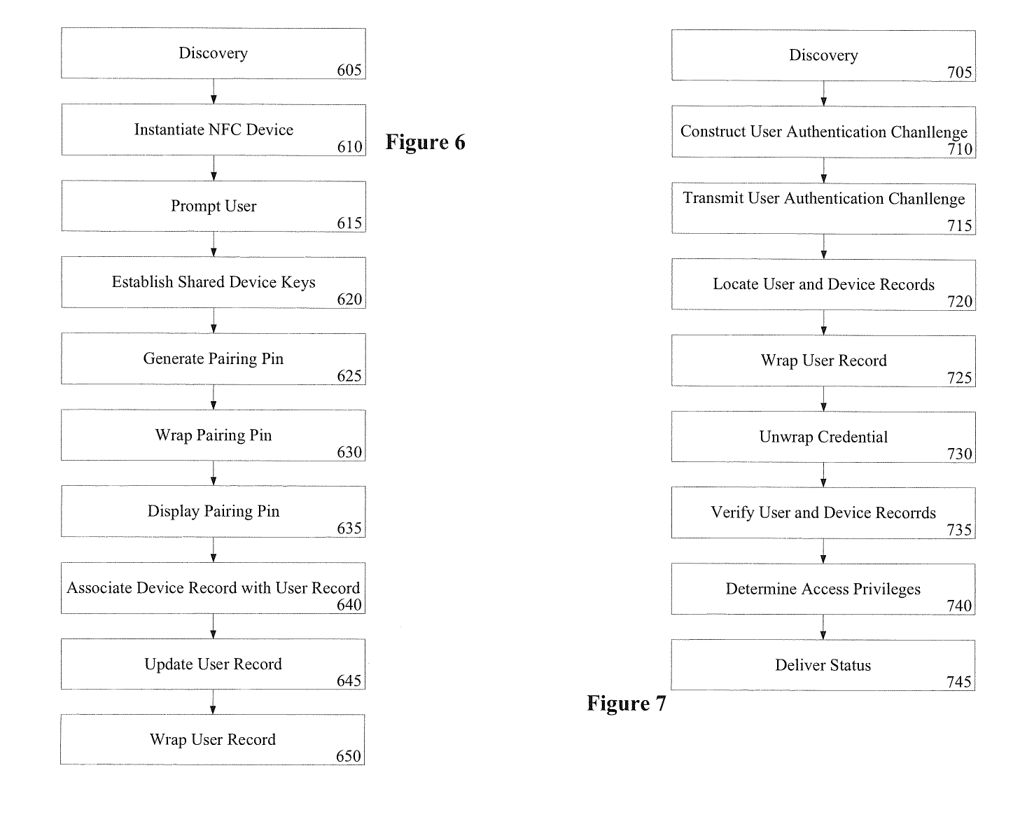

According to one embodiment, trusted execution environment 202 is implemented to provide user identity provisioning and authentication of a smartphone having NFC and/or Bluetooth capability. FIG. 6 is a flow diagram illustrating one embodiment of identity provisioning performed by trusted execution environment 202. At processing block 605. NFC or Bluetooth discovery protocols introduce the smartphone to trusted execution environment 202. In one embodiment, mirror pass module 330 is notified when the smartphone advertises that it can be used as an authentication factor.

At processing block 610, mirror pass module 330 prompts the user to configure the smartphone as an authentication factor, at which point an NFC device record is instantiated. At processing block 615, the user is prompted, via the secure input/output circuitry 130 (Protected Transaction Display), to authorize the setup. This process establishes that the user intended to pair mirror pass module 330 with the smartphone. At processing block 620, shared device keys are established between mirror pass module 330 and the smartphone. In one embodiment, the protocol optimizes for authentication performance by negotiating symmetric encryption keys. For example, a SIGMA session produces SK, MK keys for confidentiality and integrity protection.

At processing block 625, the smartphone generates a pairing PIN for display to the user, which established that the user intended to pair the smartphone with mirror pass module 330. At processing block 630, the pairing PIN is wrapped using MK/SK to establish a correct mirror pass module 330 device context. Additionally, other identification and user information may also be supplied. At processing block 635, the pairing PIN is displayed via the Protected Transaction Display. In one embodiment, the user can acknowledge that this PIN is the same that was displayed via the smartphone. (e.g., a Protected Transaction Display dialog may display an OK/CANCEL message). In such an embodiment, mirror pass module 330 recognizes that only the user could approve pairing. Although discussed above as implementing a PIN for authentication, other embodiments may feature alternative user authentication mechanisms (e.g., Quick Response (QR) Code.

At processing block 640, the smartphone device record is associated with a user record at mirror pass module 330. At processing block 645, a previously provisioned user record is updated (or a new use, record is created) at user records 334, which includes the smartphone device record. At processing block 650, the user record is wrapped using SK/MK to establish the mirror pass module 330 context and provisioning to the smartphone. In one embodiment, the user record may be abbreviated.

The above-described provisioning process requires neither trusted boot OS/drivers, nor backend server to provision smartphone. Moreover, no sensitive user identity information is visible to the Bluetooth/NFC channel. The smartphone device can verify authenticity of computing device 102, while computing device 102 can prove that the user who's identity is being paired actually authorized the pairing,

FIG. 7 is a flow diagram illustrating one embodiment of authentication performed by trusted execution environment 202. At processing block 705, Bluetooth/NFC discovery protocols introduce the smartphone to trusted execution environment 202. In one embodiment, mirror pass module 330 is notified when the smartphone advertises that it can be used as an NFC authentication factor. At processing block 710, mirror pass module 330 locates the previously stored device record from user records 334 and constructs a user authentication challenge.

At processing block 715, the user authentication challenge is transmitted to the smartphone. At processing block 720, the smartphone locates the user record and device record for mirror pass module 330. At processing block 725, the user record is wrapped using previously negotiated shared keys (MK/SK). At processing block 730, mirror pass module 330 unwraps the credential. At processing block 735, mirror pass module 330 verifies user and device record information. At processing block 740, mirror pass module 330 determines access privileges. At processing block 745, mirror pass module 330 installs the access privileges at identity protection module 350, thus indicating authorization to access various platform resources.

### Adaptive Authentication

In one embodiment, trusted execution environment 202 implements a flexible identity verification mechanism that adapts a challenge/response authentication based on a given situation. For instance, when a room is dark and not appropriate for face recognition trusted execution environment 202 platform senses user presence and lack of light for good face recognition and automatically presents alternate authentication mechanisms.

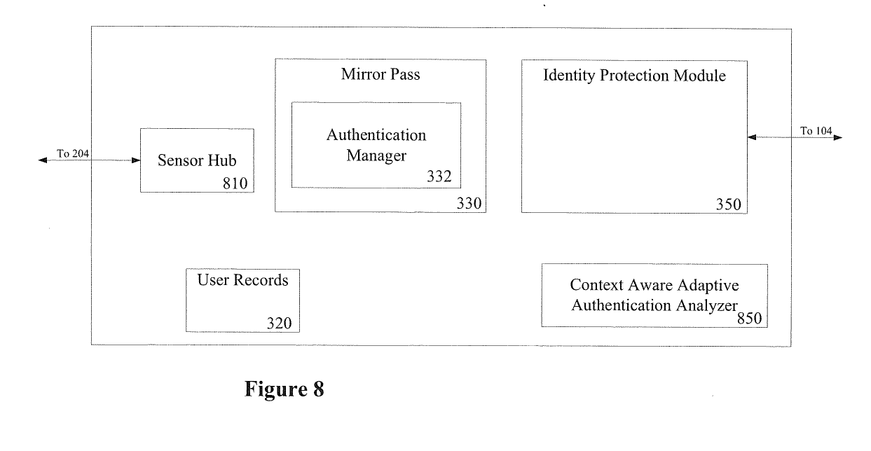

FIG. 8 is a block diagram illustrating one embodiment of a trusted execution environment 202 implemented to perform adaptive authentication. In this embodiment, trusted execution environment 202 includes sensor hub 810, and context aware adaptive authentication (CA3) analyzer 850, in addition to the previously discussed components. Sensor hub 810 is coupled to all available sensors implemented at computing device 102 via secured input/output module 206 and/or biometric capturing device 128 in order to receive sensor data.

CA3 analyzer 850 receives sensor data from sensor hub 810 and analyzes the data to dynamically determine a set of authentication factors to be used to carry out user verification. According to one embodiment, CA3 analyzer 850 evaluates computing device 102 to adapt and dynamically determine the best way to carry out an authentication challenge and response. Particularly, CA3 analyzer 850 determines which user attributes are to be verified for successful user authentication.

In one embodiment, the determination is based on information regarding external context conditions (e.g., geographical location, noise, wireless access point, stationary network equipment, etc.), platform capabilities (available sensors, OS, VPN, etc.), and/or platform state, such as internally stored information (e.g., caches, policies, profiles) and power state. For state based authentication policies, CA3 analyzer 850 may cache and profile a user based on logs and behavioral analysis to make an authentication mechanism selection. Accordingly, CA3 analyzer 850 can adapt the challenge and response based on an authentication history of a user within a particular context.

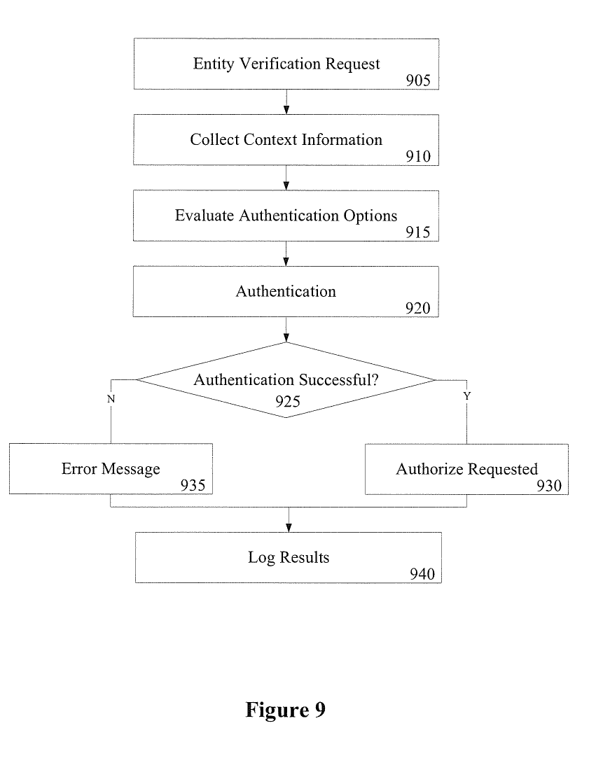

Once CA3 analyzer 850 determines the authentication method, authentication manager 335 within mirror pass module 330 takes the result and makes authentication decisions based on the determined method. FIG. 9 is a flow diagram illustrating one embodiment of the adaptive authentication process performed by trusted execution environment. At processing block 905, an entity verification request at computing device 102 is triggered by a user. In various embodiments, triggering may be an active (e.g., pressing Ctrl+Alt+Del buttons) or passive (e.g., user approaching the system) process.

At processing block 910, CA3 analyzer 850 collects context information. During this process, CA3 analyzer 850 collects context information from sensor hub 810 for external context information (e.g., noise, light, location etc.). For instance, if there is less than minimum light in a room, authentication mechanisms based on a camera such as face recognition are not considered and alternatives such as voice is instead used. During this process, CA3 analyzer 850 also gathers information from secure memory 114 for the internal context information.

At processing block 915, CA3 analyzer 850 evaluates authentication options based on the collected context in addition to authentication policies (e.g., local and IT). This results in a list of user attributes (f1, f2, f3 . . . ) with corresponding sensors (s1, s2, s3) that would be best for an upcoming authentication session. At processing block 920, authentication manager 335 performs authentication. In one embodiment, authentication manager 335 carries out the authentication process until a given authentication option is complete (e.g., all factors corresponding to an authentication option have been verified).

At decision block 925, a determination is made as to whether an authentication has been successful. If authentication is successful, the user is granted access to the system or requested resource, processing block 930. More specifically the final result may be installed at identity protection module 350 for release claims about the identity verification and strength of authentication which in turn can be used by resource providers and other platform components. If authentication is unsuccessful, access is denied and an error message is presented to the user, processing block 930. At processing block 940, the results are logged for audit and potentially long term behavioral analysis which may be used in future authentication choices.

### Context Based Remote Attestation

According to one embodiment, the above-described adaptive context authentication may be implemented in remote attestation applications may be implemented to establish a trust relationship with one or more remote computing devices (e.g., computing device 106). In such an embodiment, a remote computing device operates a cloud-based attestation service (attestation service computing device) that performs remote-attestation of local computing device 102 via hardware, installed software, sensory inputs (e.g., user presence), behavioral patterns and location based data. Thus, trusted execution environment 202 provides the cloud-based service with reliable, trustworthy and precise data for attestation, which may uniquely identify the user based on computing device 102 properties. In one embodiment the user may control which contextual information is included in the attestation. If contextual measures are combined with conventional user credentials, the reputational identity can become a strong identity typical of enterprise identity management systems.

According to one embodiment, the attestation service computing device generates an attestation result token that is transmitted back to local computing device 102 over a secure channel to trusted execution environment 202. In other embodiments, the attestation service computing device may additionally perform traditional security scanning that verifies scan results according to software module whitelists, malware blacklists, etc. Upon successful attestation, local computing device 102 is permitted to interact with another remote computing device (3^{rd} party computing device).

In such an embodiment, the 3^{rd} party computing device will have an ability to gauge the security reputation of local computing device 102 and the user, which may assist in deciding the type of policy to be applied to a transaction. In one embodiment, the token is presented and validated when the local computing device 102 connects to the 3^{rd} party computing device (e.g., a bank). In one embodiment, validation involves the 3^{rd} party computing device verifying the signature of the attestation service computing device over the token in addition to standard identification data. In one embodiment, the token is supplied by means of a secure session that is directly established between the local computing device 102 and the 3^{rd} party computing device. The secure token serves as evidence that the local computing device 102 includes the necessary qualifications to perform transactions, and that the user's contextual attributes were adequately attested to. As a result, the transaction can be securely carried out.

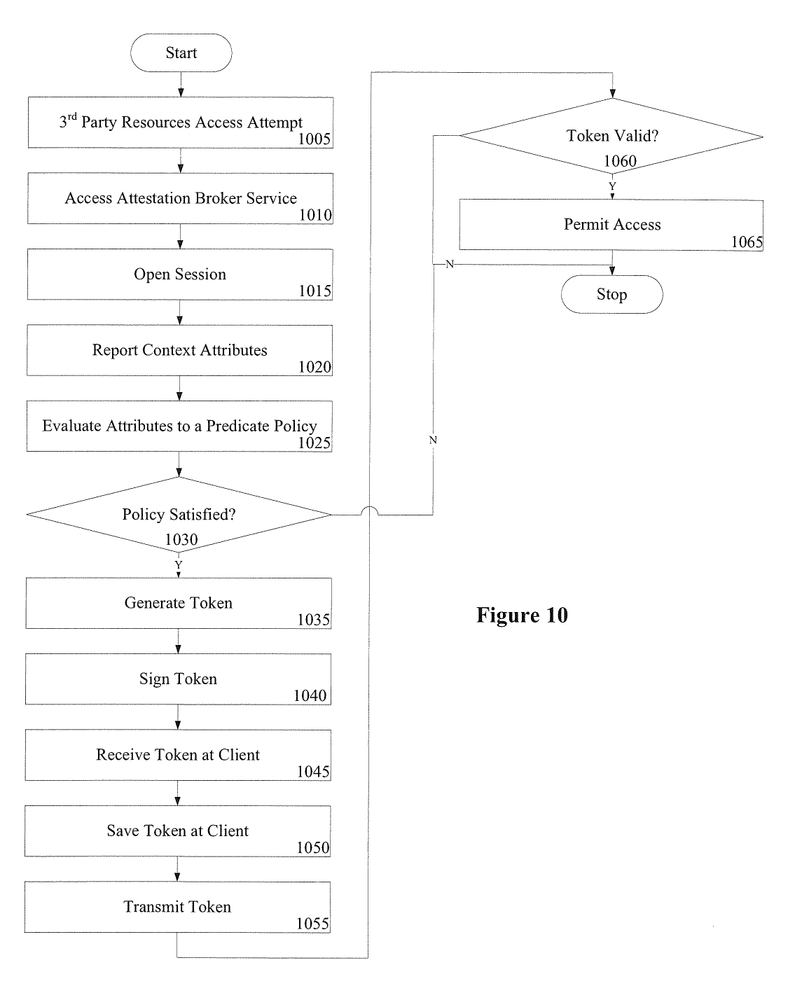

FIG. 10 is a flow diagram illustrating one embodiment of context based remote attestation process. At processing block 1005, local computing device 102 attempts to access a resource (e.g., web page) at a 3^{rd} party computing device, at which point the 3^{rd} party computing device requests an attestation token. At processing block 1010, local computing device 102 accesses an attestation service computing device. At processing block 1015, a secure communication session is established between local computing device 102 and the attestation service computing device.

In one embodiment, the communication session is implemented via the SIGMA protocol. In such an embodiment, subsequent SIGMA sessions use the token from a previous session as one of the context attributes. In a further embodiment, the attestation service computing device chooses a name by which the local computing device 102 will be known to enable the local computing device 102 to initially retain privacy. As the local computing device 102 participates in attestation, context attributes may be revealed that distinguish the local computing device 102 from other clients. This information may at some point uniquely globally identify the local computing device 102.

At processing block 1020, the local computing device 102 reports context attributes to the attestation service computing device. In one embodiment, the context attributes are combined using a mixing function (e.g. XOR) to produce the token, which is saved to be used for the next session, etc. As discussed above, the local computing device 102 can reveal distinguishable context information, which enables a user to control a privacy profile even when the 3^{rd} party computing device uses the token as an identifier around which to build a reputation profile. Thus, the 3^{rd} party computing device can reasonably mitigate fraud based on profile behaviors, but may not precisely know a local computing device 102 that exhibits suspicious behavior.

At processing block 1025, the attestation service computing device evaluates the context attributes to a predicate policy. At decision block 1030, a determination is made as to whether the policy is satisfied. If not, the process is terminated. Otherwise the token is generated, processing block 1035. At processing block 1040, the attestation service computing device signs the token with its private key. At processing block 1045, the token is received at trusted execution environment 202 within the local computing device 102. At processing block 1050, the token is saved.

At processing block 1055, the token is transmitted to the 3^{rd} party computing device. At decision block 1060, a determination is made as to whether the token is valid. In one embodiment, validation requires the local computing device 102 to authenticate by proving to the 3^{rd} party computing device that the token was issued to the local computing device 102 by the attestation service computing device. In such an embodiment, the local computing device 102 may use a Kerberos ticket to sign/encrypt the token, where the token includes an identity string of the local computing device 102. This enables the 3^{rd} party computing device to compare the identity in the token with the identity in the ticket. Further, the token may include a date stamp to enable the 3^{rd} party computing device to determine if the token is stale

In an alternative embodiment, the 3^{rd} party computing device may establish token freshness based on a nonce included in the token by the attestation service computing device that the 3^{rd} party computing device can compare to a previous message to ensure the nonce value is monotonically increasing. If at decision block 1060 the token is determined to be invalid, the process is terminated. Otherwise the 3^{rd} party computing device provides access of the resource to local computing device 102, processing block 1065.

It is to be appreciated that a lesser or more equipped system than the example described above may be preferred for certain implementations. Therefore, the configuration of computing device 102 may vary from implementation to implementation depending upon numerous factors, such as price constraints, performance requirements, technological improvements, or other circumstances. Examples of the electronic device or computing device 102 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system for facilitating content-morphism and distribution of advertisement content and user content according to embodiments and examples described herein.

Some embodiments pertain to Example 1 that includes a computing device having input/output (I/O) circuitry to receive sensory data and a trusted execution environment to monitor the I/O circuitry to detect one or more context characteristics of the computing device and to authenticate user identity based on context characteristics.

Example 2 includes the subject matter of Example 1, and wherein the trusted execution environment comprises a multi-factor authentication module to authenticate a near field communication (NFC) device.

Example 3 includes the subject matter of Example 2, and wherein the multi-factor authentication module includes an authentication manager module to authenticate the (NFC) device and a status manager to monitor the sensory data to detect the sensory data received from the I/O circuitry.

Example 4 includes the subject matter of Example 3, and wherein the status manager analyzes the sensory data to detect whether a user is in a vicinity of the user device.

Example 5 includes the subject matter of Example 4, and wherein the authentication manager receives a private key from the NFC device.

Example 6 includes the subject matter of Example 5, and further comprising an identity protection module to receive the private key from the authentication manager and secure access to resources at a remote computing device using the private key.

Example 7 includes the subject matter of Example 6, and wherein the authentication manager disables the private from the identity protection module upon the status manager detecting that the user is not in the vicinity of the user device.

Example 8 includes the subject matter of Example 5, and wherein the authentication manager generates a wrapping key and transmits the wrapping key to the NFC device.

Example 9 includes the subject matter of Example 3, and wherein the multi-factor authentication module further comprises an Open Protocol for Access Control, Identification, and Ticketing with privacy (OPACITY) module to communicate with the NFC device via an OPACITY authentication protocol

Example 10 includes the subject matter of Example 9, and wherein the OPACITY module is encrypted using storage keys from the authentication manager

Example 11 includes the subject matter of Example 2, and wherein the NFC device is a smartcard.

Example 12 includes the subject matter of Example 2, and wherein the multi-factor authentication module provisions the NFC device upon detecting that the NFC device may be used as an authentication factor.

Example 13 includes the subject matter of Example 12, and wherein the multi-factor authentication module transmits a prompt for configuration of the NFC device as an authentication factor and instantiates a record for NFC device.

Example 14 includes the subject matter of Example 13, and wherein the multi-factor authentication module establishes shared encryption keys for NFC device.

Example 15 includes the subject matter of Example 13, and wherein the multi-factor authentication module receives a pairing pin from the NFC device and transmits a prompt to a display device for user entry of the pairing pin for display.

Example 16 includes the subject matter of Example 15, and wherein the multi-factor authentication module verifies user entry of the pairing pin and associates the NFC device with a stored record.

Example 17 includes the subject matter of Example 16, and wherein the multi-factor authentication module establishes a context for the NFC device using the record.

Example 18 includes the subject matter of Example 17, and wherein the multi-factor authentication module authenticates the NFC device by transmitting an authentication challenge to the NFC device and determines access privileges for the NFC device upon verifying receipt of an authentic response to the challenge.

Example 19 includes the subject matter of Example 12, and wherein the NFC device is a NFC enabled computing device.

Example 20 includes the subject matter of Example 2, and wherein the trusted execution environment includes a sensory hub to receive the sensory data from the I/O circuitry, a context aware adaptive authentication (CA3) analyzer to analyze the sensory data and dynamically determine a method to authenticate the user identity based on characteristics of the computing device and a multi-factor authentication module to authenticate the user identity.

Example 21 includes the subject matter of Example 20, and wherein the CA3 analyzer determines the method to authenticate the user identity based on information regarding external conditions at the computing device received via the I/O circuitry.

Example 22 includes the subject matter of Example 21, and wherein the CA3 analyzer determines the method to authenticate the user identity is based on context indicating capabilities of the computing device.

Example 23 includes the subject matter of Example 22, and wherein the CA3 analyzer determines the method to authenticate the user identity is based on context indicating a state of the computing device.

Example 24 includes the subject matter of Example 23, and wherein the CA3 analyzer determines the method to authenticate the user identity is based on context indicating information stored at the computing device.

Example 25 includes the subject matter of Example 20, and further including an identity protection module to establish a trust relationship with a remote computing device based on characteristics of the computing device.

Example 26 includes the subject matter of Example 25, and wherein the identity protection receives a token from an attestation service computing device via a network and uses the token for authentication to access a third party computing device via the network.

Example 27 is a method that includes receiving sensory data at input/output (I/O) circuitry, monitoring the I/O circuitry at a trusted execution environment to detect one or more context characteristics of a computing device and the trusted execution environment authenticating user identity based on characteristics of the sensory data.

Example 28 includes the subject matter of Example 27, and wherein the trusted execution environment authenticates a near field communication (NFC) device.

Example 29 includes the subject matter of Example 28, and wherein the trusted execution environment authenticating user identity includes authenticating a near field communication (NFC) device and analyzing the sensory data to detect whether a user is in a vicinity of the user device.

Example 30 includes the subject matter of Example 29, and wherein authenticating the NFC device comprises receiving a private key from the NFC device.

Example 31 includes the subject matter of Example 30, and further including installing the private key at an identity protection module and the identity protection module securing access to resources at a remote computing device using the private key.

Example 32 includes the subject matter of Example 31, and further including removing the private key from the identity protection module upon detecting that the user is not in the vicinity of the user device.

Example 33 includes the subject matter of Example 31, and further including generating a wrapping key and transmitting the wrapping key to the NFC device.

Example 34 includes the subject matter of Example 29, and further comprising the trusted execution environment communicating with the NFC device via an Open Protocol for Access Control, Identification, and Ticketing with privacy (OPACITY) authentication protocol.

Example 35 includes the subject matter of Example 28, and further comprising provisioning the NFC device upon detecting that the NFC device may be used as an authentication factor.

Example 36 includes the subject matter of Example 35, and wherein provisioning the NFC device further includes transmitting a prompt for configuration of the NFC device as an authentication factor; and instantiating a record for NFC device.

Example 37 includes the subject matter of Example 36, and wherein provisioning the NFC device further includes establishing shared encryption keys for NFC device.

Example 38 includes the subject matter of Example 37, and wherein provisioning the NFC device further includes receiving a pairing pin from the NFC device and transmitting a prompt to a display device for user entry of the pairing pin for display.

Example 39 includes the subject matter of Example 38, and wherein provisioning the NFC device further includes verifying user entry of the pairing pin and associating the NFC device with a stored record.

Example 40 includes the subject matter of Example 39, and wherein provisioning the NFC device further includes establishing a record using a context for the NFC device.

Example 41 includes the subject matter of Example 28, and wherein authenticating the NFC device includes transmitting an authentication challenge to the NFC device and determining access privileges for the NFC device upon verifying receipt of an authentic response to the challenge.

Example 42 includes the subject matter of Example 35, and wherein the NFC device is a NFC enabled computing device.

Example 43 includes the subject matter of Example 28, and wherein the NFC device is a smartcard.

Example 44 includes the subject matter of Example 27, and further includes analyzing the sensory data after receiving the sensory data from the I/O circuitry and dynamically determining a method to authenticate the user identity based on characteristics of the computing device.

Example 45 includes the subject matter of Example 44, and wherein determining the method to authenticate the user identity is based on information regarding external conditions at the computing device received via the I/O circuitry.

Example 46 includes the subject matter of Example 45, and wherein determining the method to authenticate the user identity is based on context indicating capabilities of the computing device.

Example 47 includes the subject matter of Example 46, and wherein determining the method to authenticate the user identity is based on context indicating a state of the computing device.

Example 48 includes the subject matter of Example 47, and wherein determining the method to authenticate the user identity is based on context indicating information stored at the computing device.

Example 49 includes the subject matter of Example 44, and further including establishing a trust relationship with a remote computing device based on characteristics of the computing device.

Example 50 includes the subject matter of Example 49, and further including receiving a token from an attestation service computing device via a network and accessing a third party computing device via the network using the token for authentication.

Example 51 includes a machine-readable medium including a plurality of instructions that in response to being executed on a computing device, causes the computing device to carry out operations comprising receiving sensory data at input/output (I/O) circuitry, monitoring the I/O circuitry at a trusted execution environment to detect one or more context characteristics of a computing device and the trusted execution environment authenticating user identity based on characteristics of the sensory data.

Example 52 includes the subject matter of Example 51, and wherein the trusted execution environment authenticates a near field communication (NFC) device.

Example 53 includes the subject matter of Example 52, and wherein the trusted execution environment authenticating user identity includes authenticating a near field communication (NFC) device and analyzing the sensory data to detect whether a user is in a vicinity of the user device.

Example 54 includes the subject matter of Example 53, and wherein authenticating the NFC device comprises receiving a private key from the NFC device.

Example 55 includes the subject matter of Example 54, and further including installing the private key at an identity protection module and the identity protection module securing access to resources at a remote computing device using the private key.

Example 56 includes the subject matter of Example 55, and further including removing the private key from the identity protection module upon detecting that the user is not in the vicinity of the user device.

Example 57 includes the subject matter of Example 55, and further including generating a wrapping key and transmitting the wrapping key to the NFC device.

Example 58 includes the subject matter of Example 53, and further comprising the trusted execution environment communicating with the NFC device via an Open Protocol for Access Control, Identification, and Ticketing with privacy (OPACITY) authentication protocol.

Example 59 includes the subject matter of Example 52, and further comprising provisioning the NFC device upon detecting that the NFC device may be used as an authentication factor.

Example 60 includes the subject matter of Example 59, and wherein provisioning the NFC device further includes transmitting a prompt for configuration of the NFC device as an authentication factor; and instantiating a record for NFC device.

Example 61 includes the subject matter of Example 60, and wherein provisioning the NFC device further includes establishing shared encryption keys for NFC device.

Example 62 includes the subject matter of Example 61, and wherein provisioning the NFC device further includes receiving a pairing pin from the NFC device and transmitting a prompt to a display device for user entry of the pairing pin for display.

Example 63 includes the subject matter of Example 62, and wherein provisioning the NFC device further includes verifying user entry of the pairing pin and associating the NFC device with a stored record.

Example 64 includes the subject matter of Example 63, and wherein provisioning the NFC device further includes establishing a record using a context for the NFC device.

Example 65 includes the subject matter of Example 52, and wherein authenticating the NFC device includes transmitting an authentication challenge to the NFC device and determining access privileges for the NFC device upon verifying receipt of an authentic response to the challenge.

Example 66 includes the subject matter of Example 59, and wherein the NFC device is a NFC enabled computing device.

Example 67 includes the subject matter of Example 52, and wherein the NFC device is a smartcard.

Example 68 includes the subject matter of Example 51, and further includes analyzing the sensory data after receiving the sensory data from the I/O circuitry and dynamically determining a method to authenticate the user identity based on characteristics of the computing device.

Example 69 includes the subject matter of Example 68, and wherein determining the method to authenticate the user identity is based on information regarding external conditions at the computing device received via the I/O circuitry.

Example 70 includes the subject matter of Example 69, and wherein determining the method to authenticate the user identity is based on context indicating capabilities of the computing device.

Example 71 includes the subject matter of Example 70, and wherein determining the method to authenticate the user identity is based on context indicating a state of the computing device.

Example 72 includes the subject matter of Example 71, and wherein determining the method to authenticate the user identity is based on context indicating information stored at the computing device.

Example 73 includes the subject matter of Example 68, and further including establishing a trust relationship with a remote computing device based on characteristics of the computing device.

Example 74 includes the subject matter of Example 73, and further including receiving a token from an attestation service computing device via a network and accessing a third party computing device via the network using the token for authentication.

Example 75 includes a trusted execution environment comprising a multi-factor authentication module to monitor sensory data received at I/O circuitry to detect one or more context characteristics of a computing device and to authenticate user identity based on context characteristics.

Example 76 includes the subject matter of claim 75 wherein the multi-factor authentication module includes an authentication manager module to authenticate the (NFC) device and a status manager to monitor the sensory data to detect the sensory data received from the I/O circuitry.

Example 77 includes the subject matter of claim 76 wherein the status manager analyzes the sensory data to detect whether a user is in a vicinity of the user device.

Example 78 includes the subject matter of claim 77 wherein the authentication manager receives a private key from the NFC device.

Example 79 includes the subject matter of claim 78 further comprising an identity protection module to receive the private key from the authentication manager and secure access to resources at a remote computing device using the private key.

Example 80 includes the subject matter of claim 79 wherein the authentication manager disables the private key from the identity protection module upon the status manager detecting that the user is not in the vicinity of the user device.

Example 81 includes the subject matter of claim 78, wherein the authentication manager generates a wrapping key and transmits the wrapping key to the NFC device.

Example 82 includes the subject matter of claim 76 wherein the multi-factor authentication module further comprises an Open Protocol for Access Control, Identification, and Ticketing with privacy (OPACITY) module to communicate with the NFC device via an OPACITY authentication protocol.

Example 83 includes the subject matter of claim 82 wherein the OPACITY module is encrypted using storage keys from the authentication manager.

Example 84 includes the subject matter of claim 75 wherein the multi-factor authentication module provisions the NFC device upon detecting that the NFC device may be used as an authentication factor.

Example 85 includes the subject matter of claim 84 wherein the multi-factor authentication module transmits a user prompt via a trusted input channel for configuration of the NFC device as an authentication factor and instantiates a record for NFC device.

Example 86 includes the subject matter of claim 85 wherein the multi-factor authentication module establishes shared encryption keys for NFC device.

Example 87 includes the subject matter of claim 85 wherein the multi-factor authentication module receives a pairing pin via a trusted input channel from the NFC device and transmits a prompt to a display device for user entry of the pairing pin for display.

Example 88 includes the subject matter of claim 87 wherein the multi-factor authentication module verifies user entry of the pairing pin and associates the NFC device with a stored record.

Example 89 includes the subject matter of claim 88 wherein the multi-factor authentication module establishes a context for the NFC device using the record.

Example 90 includes the subject matter of claim 89 wherein the multi-factor authentication module authenticates the NFC device by transmitting an authentication challenge to the NFC device and determines access privileges for the NFC device upon verifying receipt of an authentic response to the challenge.

Example 91 includes the subject matter of claim 75 further including a sensor hub to receive the sensory data from the I/O circuitry, a context aware adaptive authentication (CA3) analyzer to analyze the sensory data and dynamically determine a method to authenticate the user identity based on one or more characteristics of the computing device and a multi-factor authentication module to authenticate the user identity.

Example 92 includes the subject matter of claim 91 wherein the CA3 analyzer determines the method to authenticate the user identity based on information regarding external conditions at the computing device received via the I/O circuitry.

Example 93 includes the subject matter of claim 92 wherein the CA3 analyzer determines the method to authenticate the user identity is based on context indicating capabilities of the computing device.

Example 94 includes the subject matter of claim 93 wherein the CA3 analyzer determines the method to authenticate the user identity is based on context indicating a state of the computing device.

Example 95 includes the subject matter of claim 94 wherein the CA3 analyzer determines the method to authenticate the user identity is based on context indicating information stored at the computing device.

Example 96 includes the subject matter of claim 91 further comprising an identity protection module to establish a trust relationship with a remote computing device based on characteristics of the computing device.

Example 97 includes the subject matter of claim 96 wherein the identity protection receives a token from an attestation service computing device via a network and uses the token for authentication to access a third party computing device via the network.

Example 98 includes a machine-readable medium comprising a plurality of instructions that in response to being executed on a computing device, causes the computing device to carry out operations according to any one of Examples 27 to 50.

99. Example 99 includes a system comprising a mechanism to carry out operations according to any one of claims Examples 27 to 50.
100. Example 100 includes apparatus comprising means to carry out operations according to any one of claims Examples 27 to 50.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

1. A computing device comprising:
input/output (I/O) circuitry to receive sensory data; and
a trusted execution environment to monitor the I/O circuitry to detect one or more context characteristics of the computing device and to authenticate user identity based on context characteristics.

2. The computing device of claim 1 wherein the trusted execution environment comprises a mirror pass module to authenticate a near field communication (NFC) device.

3. The computing device of claim 2 wherein the mirror pass module comprises:
an authentication manager module to authenticate the (NFC) device; and
a status manager to monitor the sensory data to detect the sensory data received from the I/O circuitry.

4. The computing device of claim 3 wherein the status manager analyzes the sensory data to detect whether a user is in a vicinity of the user device.

5. The computing device of claim 4 wherein the authentication manager receives a private key from the NFC device.

6. The computing device of claim 5 further comprising an identity protection module to receive the private key from the authentication manager and secure access to resources at a remote computing device using the private key.

7. The computing device of claim 6 wherein the authentication manager removes the private key from the identity protection module upon the status manager detecting that the user is not in the vicinity of the user device.

8. The computing device of claim 5, wherein the authentication manager generates a wrapping key and transmits the wrapping key to the NFC device.

9. The computing device of claim 3 wherein the mirror pass module further comprises an Open Protocol for Access Control, Identification, and Ticketing with privacy (OPACITY) module to communicate with the NFC device via an OPACITY authentication protocol.

10. The computing device of claim 9 wherein the OPACITY module is encrypted using storage keys from the authentication manager.

11. (canceled)

12. The computing device of claim 2 wherein the mirror pass module provisions the NFC device upon detecting that the NFC device may be used as an authentication factor.

13. The computing device of claim 12 wherein the mirror pass module transmits a prompt for configuration of the NFC device as an authentication factor and instantiates a record for NFC device.

14. The computing device of claim 13 wherein the mirror pass module establishes shared encryption keys for NFC device.

15. The computing device of claim 13 wherein the mirror pass module receives a pairing pin from the NFC device and transmits a prompt to a display device for user entry of the pairing pin for display.

16. The computing device of claim 15 wherein the mirror pass module verifies user entry of the pairing pin and associates the NFC device with a stored record.

17. The computing device of claim 16 wherein the mirror pass module establishes a context for the NFC device using the record.

18. The computing device of claim 17 wherein the mirror pass module authenticates the NFC device by transmitting an authentication challenge to the NFC device and determines access privileges for the NFC device upon verifying receipt of an authentic response to the challenge.

19. (canceled)

20. The computing device of claim 2 wherein the trusted execution environment comprises:
a sensory hub to receive the sensory data from the I/O circuitry;
a context aware adaptive authentication (CA3) analyzer to analyze the sensory data and dynamically determine a method to authenticate the user identity based on characteristics of the computing device; and
a mirror pass module to authenticate the user identity.

21. The computing device of claim 20 wherein the CA3 analyzer determines the method to authenticate the user identity based on information regarding external conditions at the computing device received via the I/O circuitry.

22. The computing device of claim 21 wherein the CA3 analyzer determines the method to authenticate the user identity is based on context indicating capabilities of the computing device.

23. The computing device of claim 22 wherein the CA3 analyzer determines the method to authenticate the user identity is based on context indicating a state of the computing device.

24. The computing device of claim 23 wherein the CA3 analyzer determines the method to authenticate the user identity is based on context indicating information stored at the computing device.

25. The computing device of claim 20 further comprising an identity protection module to establish a trust relationship with a remote computing device based on characteristics of the computing device.

26. The computing device of claim 25 wherein the identity protection receives a token from an attestation service computing device via a network and uses the token for authentication to access a third party computing device via the network.

27. A method comprising:
receiving sensory data at input/output (I/O) circuitry; and
monitoring the I/O circuitry at a trusted execution environment to detect one or more context characteristics of a computing device; and
the trusted execution environment authenticating user identity based on characteristics of the sensory data.

28. The method of claim 27 wherein the trusted execution environment authenticates a near field communication (NFC) device.

29. The method of claim 28 wherein the trusted execution environment authenticating user identity comprises:
authenticating a near field communication (NFC) device; and
analyzing the sensory data to detect whether a user is in a vicinity of the user device.

30. The method of claim 29 wherein authenticating the NFC device comprises receiving a private key from the NFC device.

31. The method of claim 30 further comprising:
installing the private key at a identity protection module; and
the identity protection module securing access to resources at a remote computing device using the private key.

32. The method of claim 31 further comprising removing the private key from the identity protection module upon detecting that the user is not in the vicinity of the user device.

33. The method of claim 31 further comprising:
generating a wrapping key; and
transmitting the wrapping key to the NFC device.

34. The method of claim 29 further comprising the trusted execution environment communicating with the NFC device via an Open Protocol for Access Control, Identification, and Ticketing with privacy (OPACITY) authentication protocol.

35. The method of claim 28 further comprising provisioning the NFC device upon detecting that the NFC device may be used as an authentication factor.

36. The method of claim 35 wherein provisioning the NFC device further comprises:
transmitting a prompt for configuration of the NFC device as an authentication factor; and
instantiating a record for NFC device.

37. The method of claim 35 wherein provisioning the NFC device further comprises establishing shared encryption keys for NFC device.

38. The method of claim 37 wherein provisioning the NFC device further comprises:
receiving a pairing pin from the NFC device; and
transmitting a prompt to a display device for user entry of the pairing pin for display.

39. The method of claim 38 wherein provisioning the NFC device further comprises:
verifying user entry of the pairing pin; and
associating the NFC device with a stored record.

40. The method of claim 39 wherein provisioning the NFC device further comprises establishing a record using a context for the NFC device.

41. The method of claim 28 wherein authenticating the NFC device comprises:
transmitting an authentication challenge to the NFC device; and
determining access privileges for the NFC device upon verifying receipt of an authentic response to the challenge.

42-43. (canceled)

44. The method of claim 27 further comprising:
analyzing the sensory data after receiving the sensory data from the I/O circuitry; and
dynamically determining a method to authenticate the user identity based on characteristics of the computing device.

45. The method of claim 44 wherein determining the method to authenticate the user identity is based on information regarding external conditions at the computing device received via the I/O circuitry.

46. The method of claim 45 wherein determining the method to authenticate the user identity is based on context indicating capabilities of the computing device.

47. The method of claim 46 wherein determining the method to authenticate the user identity is based on context indicating a state of the computing device.

48. The method of claim 47 wherein determining the method to authenticate the user identity is based on context indicating information stored at the computing device.

49. The method of claim 44 further comprising establishing a trust relationship with a remote computing device based on characteristics of the computing device.

50. The method of claim 49 further comprising:
receiving a token from an attestation service computing device via a network: and
accessing a third party computing device via the network using the token for authentication.

51. A machine-readable medium comprising a plurality of instructions that in response to being executed on a computing device, causes the computing device to carry out operations comprising:
receiving sensory data at input/output (I/O) circuitry; and
monitoring the I/O circuitry at a trusted execution environment to detect one or more context characteristics of a computing device; and
the trusted execution environment authenticating user identity based on characteristics of the sensory data.

52. The machine-readable medium of claim 51 wherein the trusted execution environment authenticates a near field communication (NFC) device.

53. The machine-readable medium of claim 52 wherein the trusted execution environment authenticating user identity comprises:
authenticating a near field communication (NFC) device; and
analyzing the sensory data to detect whether a user is in a vicinity of the user device.

54. The machine-readable medium of claim 53 wherein authenticating the NFC device comprises receiving a private key from the NFC device.
